(19) United States
(12) Patent Application Publication
(10) Pub. No.: US 2025/0317849 A1
(43) Pub. Date: Oct. 9, 2025

(54) DEVICES AND METHODS FOR NETWORK ENERGY OPTIMIZATION

(71) Applicant: HUAWEI TECHNOLOGIES CO., LTD., Shenzhen (CN)

(72) Inventors: Youcef Magnouche, Boulogne Billancourt (FR); Jérémie Leguay, Boulogne Billancourt (FR); Feng Zeng, Nanjing (CN)

(73) Assignee: HUAWEI TECHNOLOGIES CO., LTD., Shenzhen (CN)

(21) Appl. No.: 19/244,964

(22) Filed: Jun. 20, 2025

Related U.S. Application Data
(63) Continuation of application No. PCT/EP2022/087158, filed on Dec. 21, 2022.

(51) Int. Cl. H04W 52/02

(52) U.S. Cl. CPC H04W 52/0206

(57) ABSTRACT

The present disclosure relates to energy optimization for links aggregated groups. An apparatus hosted inside a network device is disclosed to coordinate multiple LAGs to turn on/off components of the network device. The apparatus is adapted to decide which components to turn on/off based on a device layout of the network device and coordinate the decision with neighbor network device(s). Thanks to the use of the device layout, a more informed energy optimization decision can be taken. To this end, the apparatus obtains an energy profile of the network device. The energy profile comprises the device layout and energy consumption information associated with each component of the network device. The apparatus further obtains traffic information of the multiple LAGs and optimizes the energy consumption based on the device layout and traffic information. The optimization decision may be coordinated with neighbor network device(s).

### CROSS-REFERENCE TO RELATED APPLICATIONS

This application is a continuation of International Application No. PCT/EP2022/087158, filed on Dec. 21, 2022, the disclosure of which is hereby incorporated by reference in its entirety.

### FIELD

The present disclosure relates generally to the field of communication technology. For instance, the present disclosure relates to devices and methods for optimizing network energy consumption.

### BACKGROUND

Global warming has become a major concern for several decades. The information and communications technology (ICT) sector accounts for between 5% and 9% of the global electricity consumption per year, which makes it an important part of the global electricity consumption per year. Manufacturers have an urgent need to design novel mechanisms and methods to optimize energy. With global data traffic expected to grow around 60% per year, the industry's share is expected to grow further unless investments in energy efficiency and renewables can offset the effect. Networking devices are wasting a considerable amount of power as many resources (i.e., routers and links) are powered on without being fully utilized.

In high-capacity networks such as backbone networks for operators or data centers, multiple parallel links are aggregated to get a high capacity between routers. A common protocol to manage parallel links is Institute of Electrical and Electronics Engineers (IEEE) 802.3ad standard that defines a Link Aggregation Control Protocol (LACP). The LACP provides a link aggregation feature to aggregate one or more Ethernet interfaces to form a logical point-to-point link, known as a Link Aggregation Group (LAG), virtual link, trunk or bundle.

### SUMMARY

In the context of LAGs, one key feature for energy savings is the possibility to adjust the LAG capacity as a function of the traffic demand. In other words, it can provide the possibility to turn on/off physical links (e.g. ports) based on traffic. Some conventional methods enable a management of link aggregation groups to save energy by only activating the minimum number of links necessary to sustain traffic. However, conventional methods focus on links and are based on “trial and error.”

In view of the above-mentioned problems and disadvantages, the present disclosure improves network energy-saving mechanisms by providing a way for each network device to optimize its local energy consumption in coordination with its neighbors.

Embodiments of the present disclosure enable consideration of all adjacent links to coordinate multiple LAGs in order to maximize energy savings, and also to consider device layout of each network device to turn on/off components (e.g. boards, chipsets, and ports) to further increase energy savings.

A first aspect of the present disclosure provides an apparatus for optimizing energy consumption of a network device. The network device is connectable with one or more neighboring network devices. Each network device comprises multiple components. The apparatus is configured to:
obtain an energy profile of the network device, wherein the energy profile comprises a device layout of the network device and energy consumption information associated with each component;
obtain traffic information of the network device, wherein the network device is associated with multiple LAGs;
optimize the energy consumption of the network device by determining one or more of the components of the network device to be set in a low-power state, based on the device layout and the traffic information; and
request the one or more neighboring network devices to set one or more respective components in a low-power state based on topology of the multiple LAGs and the one or more components of the network device to be set in a low-power state.

In an embodiment of the present disclosure, the component of the network device may refer to any one of a board, a chipset, or a port of the network device. The device layout of the network device may comprise information on relationships between the multiple components of the network device.

In this way, the energy optimization performed by the apparatus can leverage the device layout to avoid making sub-optimal decisions, and the energy-saving gains can be further increased.

In an implementation form of the first aspect, for obtaining the energy profile of the network device, the apparatus may be configured to receive the energy profile of the network device from a controller device.

By obtaining and considering the energy profile of the network device for energy optimization, the apparatus is able to perform energy optimization not only for ports connecting each LAG, but also for other internal components of the network device where further energy-saving gains can be obtained. In this way, the energy-saving gains can be further increased.

In a further implementation form of the first aspect, the apparatus may be further configured to inform the one or more neighboring network devices about the one or more components that are to be set to the low-power state.

In this way, coordinated energy optimization can be achieved among adjacent network devices.

In a further implementation form of the first aspect, the apparatus may be further configured to obtain, from a respective neighboring network device, an indication of one or more components of the respective neighboring network device that are to be set to the low-power state.

In an embodiment of the present disclosure, the indication may be seen as a local decision or suggestion that is made by the respective neighboring network device for energy optimization. The apparatus may be configured to take this indication into consideration for performing energy optimization of the network device.

In this way, the energy-saving gains can be further increased from the respective neighbor network devices and the overall energy-saving gains of the network can be further increased.

In a further implementation form of the first aspect, the apparatus may be further configured to:
intersect the one or more of the components of the network device that are set to the low-power state and the one or more components of the respective neighboring network devices that are set to the low-power state, to obtain a list of links to be adjusted; and
optimize the energy consumption of the network device by adjusting the links in the multiple LAGs according to the list.

In a further implementation form of the first aspect, wherein the apparatus may be further configured to provide the list of links to be adjusted to the one or more neighboring network devices.

In an embodiment of the present disclosure, the list of links to be adjusted may comprise information about one or more components (e.g. ports) that are to be turned off. In each LAG, components between adjacent network devices may have a one-to-one correspondence. In this way, the neighboring network device may be adapted to turn off its component(s), correspondingly.

In a further implementation form of the first aspect, the apparatus may be configured to optimize the energy consumption of the network device based on a distributed algorithm, wherein according to the distributed algorithm the apparatus is configured to:
obtain energy consumption information of the network device;
broadcast the energy consumption information of the network device;
receive further energy consumption information of one or more further network devices; and
optimize the energy consumption of the network device in response to determining that the energy consumption information of the network device is the highest among the energy consumption information of the network device and the further energy consumption information of one or more further network devices.

In a further implementation form of the first aspect, the apparatus may be configured to receive a device capability indication from a respective neighboring network device, wherein the device capability indication indicates whether the respective neighboring network device comprises a further apparatus adapted to perform energy optimization.

When the respective neighboring network device comprises the further apparatus, the apparatus may be adapted to receive a local energy optimization decision made by the further apparatus, and take this local energy optimization decision into consideration for performing the energy optimization.

For instance, the local energy optimization decision may comprise one or more ports of the respective neighboring network devices that are suggested to be turned off, whereas the apparatus may make a preliminary decision to turn off one or more ports of the network device. In this case, the apparatus may be adapted to intersect the one or more to-be-turned-off ports of the respective neighboring network devices and the one or more to-be-turned-off ports of the network device to reach a final decision.

In a further implementation form of the first aspect, the network device and the one or more further network devices may be in a stable set. Any two network devices in the stable set are not neighboring network devices.

The stable set can be used to avoid a negotiation phase between the network device and its one or more neighboring network devices. At each iteration, only one node in a given neighborhood is adapted to make a final decision to optimize energy. Since any two network devices in the stable set are not neighboring network devices, each network device in the stable set may, at each iteration, perform energy optimization without negotiating with respective neighboring network device(s). In this way, stability and efficiency for performing the energy optimization can be ensured.

In a further implementation form of the first aspect, the apparatus may be configured to optimize the energy consumption of the network device periodically.

In this way, no additional signaling/messaging is required and energy optimization can be performed autonomously.

In a further implementation form of the first aspect, the apparatus may be configured to optimize the energy consumption of the network device based on a triggering message received from one of the one or more neighboring network devices.

In a further implementation form of the first aspect, the apparatus may be configured to optimize the energy consumption of the network device based on a threshold. The threshold may be associated with an energy consumption of the network device and a current traffic status of the network device.

In this way, the energy optimization can be performed based on a demand basis.

In a further implementation form of the first aspect, for optimizing the energy consumption of the network device, the apparatus may be further configured to send a lock message to the one or more neighboring network devices. The lock message is used to instruct the one or more neighboring network devices not to perform energy optimization.

In this way, no conflicting energy optimization can be performed among adjacent network devices, and the efficiency of energy optimization is ensured.

In a further implementation form of the first aspect, the lock message may comprise a time duration and the lock message is further used to instruct the one or more neighboring devices not to perform energy optimization at least within the time duration.

In a further implementation form of the first aspect, the apparatus may be further configured to send an unlock message to the one or more neighboring network devices. The unlock message is used to cancel the lock message.

In a further implementation form of the first aspect, the traffic information may comprise network requirements for the multiple LAGs. In an embodiment of the present disclosure, each network requirement may be one of a bandwidth requirement, Quality-of-Service (QOS) requirement, and link utilization threshold of a respective LAG.

A second aspect of the present disclosure provides a network device comprising the apparatus according to the first aspect or any implementation form thereof.

In an implementation form of the second aspect, the network device may be a router, a switch, a repeater, a bridge, or a gateway.

A third aspect of the present disclosure provides a method for optimizing energy consumption of a network device. The network device is connectable with one or more neighboring network devices. Each network device comprises multiple components. The method comprises the following steps:
obtaining, by an apparatus, an energy profile of the network device, wherein the energy profile comprises a device layout of the network device and energy consumption information associated with each component;
obtaining, by the apparatus, traffic information of the network device, wherein the network device is associated with multiple link aggregation groups, LAGs;
optimizing, by the apparatus, the energy consumption of the network device by determining one or more of the components of the network device to be set in a low-power state, based on the device layout and the traffic information; and
requesting, by the apparatus, the one or more neighboring network devices to set one or more respective components in a low-power state based on topology of the multiple LAGs.

In an implementation form of the third aspect, the step of obtaining the energy profile of the network device may comprise receiving the energy profile of the network device from a controller device.

In a further implementation form of the third aspect, the method may further comprise informing, by the apparatus, the one or more neighboring network devices about the one or more components that are to be set to the low-power state.

In a further implementation form of the third aspect, the method may further comprise obtaining, by the apparatus from a respective neighboring network device, an indication of one or more components of the respective neighboring network device that are to be set to the low-power state.

In a further implementation form of the third aspect, the method may further comprise:
intersecting, by the apparatus, the one or more of the components of the network device that are set to the low-power state and the one or more components of the respective neighboring network devices that are set to the low-power state, to obtain a list of links to be adjusted; and
optimizing, by the apparatus, the energy consumption of the network device by adjusting the links in the multiple LAGs according to the list.

In a further implementation form of the third aspect, the method may further comprise providing, by the apparatus, the list of links to be adjusted to the one or more neighboring network devices.

In a further implementation form of the third aspect, the energy consumption of the network device may be optimized based on a distributed algorithm. According to the distributed algorithm the method may comprise:
obtaining, by the apparatus, energy consumption information of the network device;
broadcasting, by the apparatus, the energy consumption information of the network device;
receiving, by the apparatus, further energy consumption information of one or more further network devices; and
optimizing, by the apparatus, the energy consumption of the network device in response to determining that the energy consumption information of the network device is the highest among the energy consumption information of the network device and the further energy consumption information of one or more further network devices.

In a further implementation form of the second aspect, the method may further comprise: receiving, by the apparatus, a device capability indication from a respective neighboring network device, wherein the device capability indication indicates whether the respective neighboring network device comprises a further apparatus adapted to perform energy optimization.

When the respective neighboring network device comprises the further apparatus, the method may further comprise: receiving, by the apparatus, a local energy optimization decision made by the further apparatus, and taking this local energy optimization decision into consideration, by the apparatus for performing the energy optimization.

In a further implementation form of the third aspect, the network device and the one or more further network devices may be in a stable set. Any two network devices in the stable set are not neighboring network devices.

In a further implementation form of the third aspect, the energy consumption of the network device may be optimized periodically.

In a further implementation form of the third aspect, the energy consumption of the network device may be optimized based on a triggering message received by the apparatus from one of the one or more neighboring network devices.

In a further implementation form of the third aspect, the method may be configured to optimize the energy consumption of the network device based on a threshold. The threshold may be associated with an energy consumption of the network device and a current traffic status of the network device.

In a further implementation form of the third aspect, the step of optimizing the energy consumption of the network device may further comprise sending, by the apparatus, a lock message to the one or more neighboring network devices. The lock message is used to instruct the one or more neighboring network devices not to perform energy optimization.

In a further implementation form of the third aspect, the lock message may comprise a time duration and the lock message is further used to instruct the one or more neighboring devices not to perform energy optimization at least within the time duration.

In a further implementation form of the third aspect, the method may further comprise sending, by the apparatus, an unlock message to the one or more neighboring network devices. The unlock message is used to cancel the lock message.

In a further implementation form of the third aspect, the traffic information may comprise network requirements for the multiple LAGs. In an embodiment of the present disclosure, each network requirement may be one of a bandwidth requirement, QoS requirement, and link utilization threshold of a respective LAG.

The method of the third aspect may share the same advantages and benefits as the apparatus of the first aspect.

A fourth aspect of the present disclosure provides a computer program comprising a program code for performing the method according to the third aspect or any of its implementation forms.

A fifth aspect of the present disclosure provides a non-transitory storage medium storing executable program code which, when executed by a processor, causes the method according to the third aspect or any of its implementation forms to be performed.

A sixth aspect of the present disclosure provides a chipset comprising a memory and a processor, which are configured to store and execute program code to perform the method according to the third aspect or any of its implementation forms.

It should be noted that all devices, elements, units, and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following disclosure, a specific functionality or step to be performed by external entities is not reflected in the description of a specific detailed element of that entity, which performs that specific step or functionality, it should be clear for a skilled person that these methods and functionalities can be implemented in respective software or hardware elements, or any kind of combination thereof.

### BRIEF DESCRIPTION OF DRAWINGS

The above-described aspects and implementation forms will be explained in the following description of specific embodiments in relation to the enclosed drawings, in which

FIG. 1 shows an apparatus for energy optimization according to embodiments of the present disclosure;

FIG. 2 shows a network device hosting an energy optimization agent according to embodiments of the present disclosure;

FIG. 3 shows a process performed by an energy optimization agent according to embodiments of the present disclosure;

FIG. 4 shows a diagram of a method according to embodiments of the present disclosure;

FIGS. 5A and 5C show an example of energy optimization according to embodiments of the present disclosure and FIG. 5B shows a conventional method of energy optimization; and

FIG. 6 shows an example of a stable set according to embodiments of the present disclosure.

### DETAILED DESCRIPTION

The present disclosure provides an energy optimization agent (or simply referred to as an “agent”). The agent may reside inside network devices to coordinate multiple LAGs to turn on/off components of the network device. In the present disclosure, the network device may be referred to as a network node or a node.

For instance, the agent may be hosted at a router and decide which components (e.g. boards, chipsets, and ports) to switch on/off based on a detailed layout of the physical parts and in coordination with neighbor nodes. The neighbor nodes may also comprise a corresponding agent.

Each agent may follow a process at each iteration. The process may comprise the following steps. Firstly, each agent may be adapted to decide whether to optimize energy of the corresponding node. Secondly, each agent may be adapted to determine which component(s) of the corresponding node to turn on/off. Thirdly, each agent is adapted to negotiate with their neighbors. Fourthly, check whether all the agents reach a consensus decision. If yes, all the agent is adapted to execute the consensus decision. If not, another iteration of the four steps shall be executed again by all the agents. The process may be executed synchronously or asynchronously.

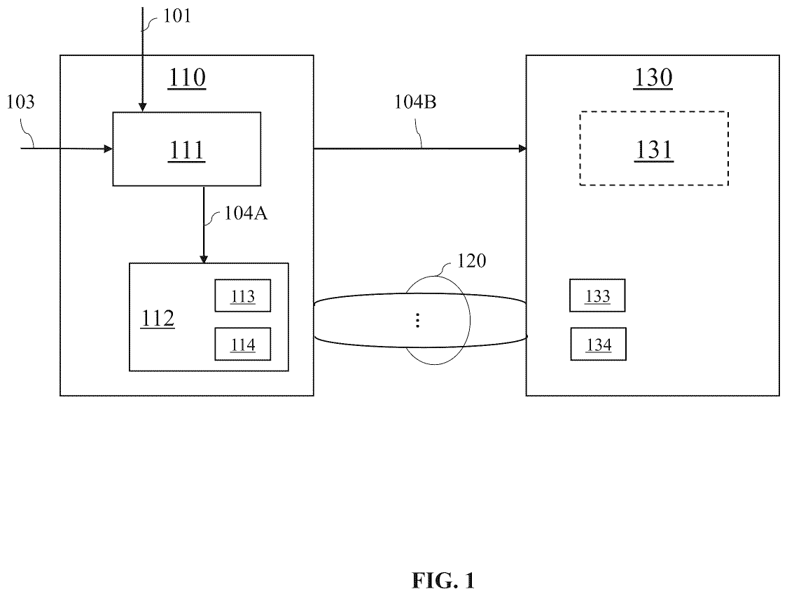

In the FIGS. 1 to 5, corresponding elements may share the same features and may function likewise.

FIG. 1 shows an apparatus 111 for energy optimization according to embodiments of the present disclosure. The apparatus 111 is configured to optimize energy consumption of a network device 110. Hence, the apparatus 111 may also be referred to as an energy optimization agent or an agent 111. In an embodiment of the present disclosure, the agent 111 may be located inside the network device 110, or may be a functional unit of the network device 110. In the present disclosure, the network device 110 may also be referred to as a “target network device” or a “target node” 110. The target network device 110 is connectable with one or more neighboring network devices 130, e.g., in a communications network such as an Ethernet network. A neighboring network device may be referred to as a “neighbor node” 130. Each network device 110 comprises multiple components. For instance, a component may be a board 112, a chipset 113, or a port 114. Each component may be set to different power states, such as full-on, energy-saving mode, sleep mode, shut-off. Generally, each component can be turned on or turned off.

The agent 111 is configured to obtain an energy profile 101 of the target network device. The energy profile 101 comprises a device layout of the target network device and energy consumption information associated with each component. The device layout may comprise topology information on the components of the target network device 110, such as connections and/or dependencies of the components. For instance, the target network device 110 may comprise three boards. Each board may comprise (or may be adapted to control) one or more chipsets. Each chipset may comprise (or may be adapted to control) one or more ports. The information about connections and/or dependencies among the boards, chipsets, and ports may be comprised in the device layout. Moreover, the agent 111 is further configured to obtain energy consumption information associated with each component. For instance, a board may consume 100 Watt (W), a chipset of the board may consume 70 W, and a port of the chipset may consume 40 W. The device layout and energy consumption information may be known to the target network device and may be provided to the agent as inputs for optimizing energy consumption. In embodiments of the present disclosure, the target network device 110 may be adapted to obtain the energy profile 101 from a control device of the network.

The agent 111 is further configured to obtain traffic information 103 of the target network device 110. The target network device is associated with multiple LAGs. Each LAG may comprise one or more links. Each link may be used to connect a port of the target node and a port of the neighbor node. In an embodiment of the present disclosure, each link of a LAG 120 may be turned on/off in order to save energy.

In embodiments of the present disclosure, the traffic information 103 may comprise network requirements for the multiple LAGs, wherein the network requirements comprise one or more of a bandwidth requirement, QoS requirement, and link utilization threshold of a respective LAG.

In the present disclosure, the agent 111 is adapted to coordinate the multiple LAGs based on the obtained traffic information 103 and the energy profile 101 (e.g., the device layout, and the energy consumption information). That is, the agent 111 is configured to optimize the energy consumption of the target network device 110 by determining one or more of the components of the target network device 110 to be set in a low-power state, based on the energy profile 101 and the traffic information 103. The agent 111 may send a request 104A indicating this determination (or “decision”) to the one or more components, so that the one or more components are turned on/off, respectively, according to the decision. The agent 111 may be further configured to send a further request 104B comprising the decision to the neighbor node 130, so that the neighbor node 130 can be adapted to turn on/off its components correspondingly.

In an embodiment of the present disclosure, one component (or referred to as “parent component”) 112 of the target node 110 may comprise one or more sub-components 113, 114 (or referred to as “child components”). The agent may be further configured to set the parent component 112 into a low-power state responsive to determining that all the one or more child components 113, 114 of the parent component 112 are set into a low-power state. For instance, as exemplarily illustrated in FIG. 1, the target node may comprise a chipset 112. The chipset 112 may comprise two ports 113, 114. Other possible components may be further comprised in the target network device 110, which are not shown in FIG. 1. For example, the chipset 112 may be located on a board. When all the child components 113, 114 are turned off as a decision of the energy optimization, the target network device 110 is further configured to turn off the parent component 112. The relationship (e.g., connections and dependencies) of the components (e.g., parent component and child component) may be comprised in the device layout. By taking account of the device layout for energy optimization, energy saving can be further increased.

It is noted that the low-power state may be referred to a state that a respective component is not in operation. For instance, the low-power state may be a sleeping state, or a hibernation (sleep) state, or a switched-off state. In this disclosure, as long as a component is in an energy-saving state, or sleep state, this component can be seen as turned off or in a low-power state. In this disclosure, “in a low-power state” and “turned off” may be used interchangeably.

In an embodiment of the present disclosure, the traffic information 103 may comprise topological links and bandwidth requirements between the target network device and the one or more neighboring devices. For instance, the traffic information 103 may comprise the following information: {node 1, node 2, 20 Mbps}, {node 1, node 3, 50 Mbps}, which means that a (minimum) 20 Mbps link shall be required between node 1 and node 2, and a (minimum) 50 Mbps link shall be required between node 1 and 3. Node 1 in this example may be the target network device 110, nodes 2 and 3 in this example may be the neighboring network devices.

In the present disclosure, a practical constraint may be to keep at least one physical link active inside each LAG to avoid disruption at Ethernet Layer 3 (routing).

The agent 111 is further configured to request the one or more neighboring network devices to set one or more respective components in a low-power state based on topology of the multiple LAGs and the one or more components of the network device to be set in a low-power state. It is noted that one LAG 120 is shown in FIG. 1. When a respective LAG (or a component of the target node) is turned on/off, component(s) of the neighbor node that corresponds to the respective LAG are also turned on/off. For instance, the neighbor node 130 may comprise a first port 133 corresponding to port 113 of the target node 110, and a second port 134 corresponding to port 114 of the target node 110. If the agent 110 decides to turn off port 113 (or LAG #1 where port 113 is assigned) and informs the neighbor node 130 about this decision, the neighbor node 130 correspondingly turns off the first port 133.

In this way, all adjacent links are taken into consideration to coordinate the multiple LAGs in order to maximize (or further increase) energy savings. Moreover, the energy optimization further takes the device layout into consideration, which can further increase energy savings.

In an embodiment of the present disclosure, the neighbor node 130 may comprise its own further agent (or referred to as “neighbor agent”) 131. The neighbor agent 131 may be configured to make a local decision (or suggestion) for energy optimization. The neighbor node 130 may then send the suggestion to the target node 110. The target node 110 may be configured to intersect the suggestion and the decision of its own. If a consensus decision can be reached, the target node 110 may be configured to optimize the energy consumption according to the consensus decision. By performing energy optimization in a coordinated manner among adjacent nodes, energy saving can be further improved.

In embodiments of the present disclosure, the neighbor node 130 may be configured to send an indication of device capabilities to the target node 110. The indication may be used to indicate whether the neighbor node 130 comprises a neighbor agent (or whether the neighbor node 130 can provide a suggestion for energy optimization). The target node 110 may be then configured to take the suggestion from the neighbor node 130 into consideration for performing energy optimization when the indication is positive.

It is noted that since the energy optimization agent 111 is hosted in the target node 110, functions in the present disclosure that are executable by the agent 111 may be seen as executable by the target node 110 where applicable. For instance, interactions between the agent 111 and the neighbor node 130 can be seen as interactions between the target node 110 and the neighbor node 130.

In an embodiment of the present disclosure, each node may be any one of a router, a switch, a repeater, a bridge, and a gateway.

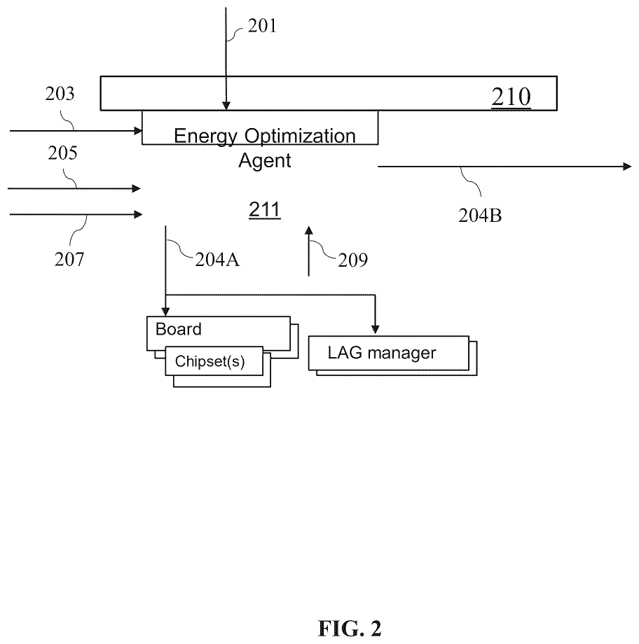

FIG. 2 shows a network device (or target node) 210 hosting an energy optimization agent 211 according to embodiments of the present disclosure.

The energy optimization agent 211 may be firstly configured to determine whether an associated target node 210 needs energy optimization. If yes, the energy optimization agent 211 is configured to determine which component(s) of the target node 210 to switch on/off and request one or more neighbor nodes to switch on/off related links of the multiple LAGs.

In order to obtain inputs for optimizing the energy consumption of the target node, the energy optimization agent is configured to obtain an energy profile 201 of the target node and traffic information 203 of the LAGs. In an embodiment of the present disclosure, the energy optimization agent may be further configured to receive, from a respective neighbor node, an indication 205 of device capabilities of the neighbor node. The indication 205 may, for example, indicate whether a further agent is hosted on the neighbor node. In embodiments of the present disclosure, when there is a further agent hosted on the neighbor node, the energy optimization agent may be further configured to receive, from the further agent, a corresponding energy consumption information 207 of the neighbor node. The energy consumption information 207 may, for instance, comprise information on an overall power consumption of the neighbor node. The overall power consumption may be used for, for instance, determining which node should perform energy optimization. In this example, it is decided that the target node 210 is the node that performs energy optimization. The energy consumption information 207 may be used for determining a stable set, which is to be addressed later on. In an embodiment of the present disclosure, traffic statistics per link 209 may be provided by a LAG manager of the target node 210 to the agent 211.

As an output for optimizing the energy consumption of the target node 210, one or more of the components of the target node 210 are determined by the agent to be set to a low-power state (while the remaining components are determined to be switched on). The agent 211 may be adapted to send a request message 204A to the components. The agent 211 may be further configured to send a similar request message 204B to one or more neighbor nodes. The request message 204B sent to the neighbor node may comprise components of the target node that are to be set in a low-power state. In this way, the request message 204B may be used for requesting the one or more neighbor nodes to set one or more respective components in the low-power state. The one or more respective components of the neighbor node to be set in the low-power mode may be determined based on the topology of the multiple LAGs and the one or more components of the target node to be set in the low-power state. For instance, if port #11 of a target node #1 is to be switched off, according to the topology of the LAGs, port #21 of a neighbor node #2 connecting with port #11 is also to be switched off. The optimization may be negotiated with the neighbor node. The negotiation may be iterated several rounds until a consensus decision is reached.

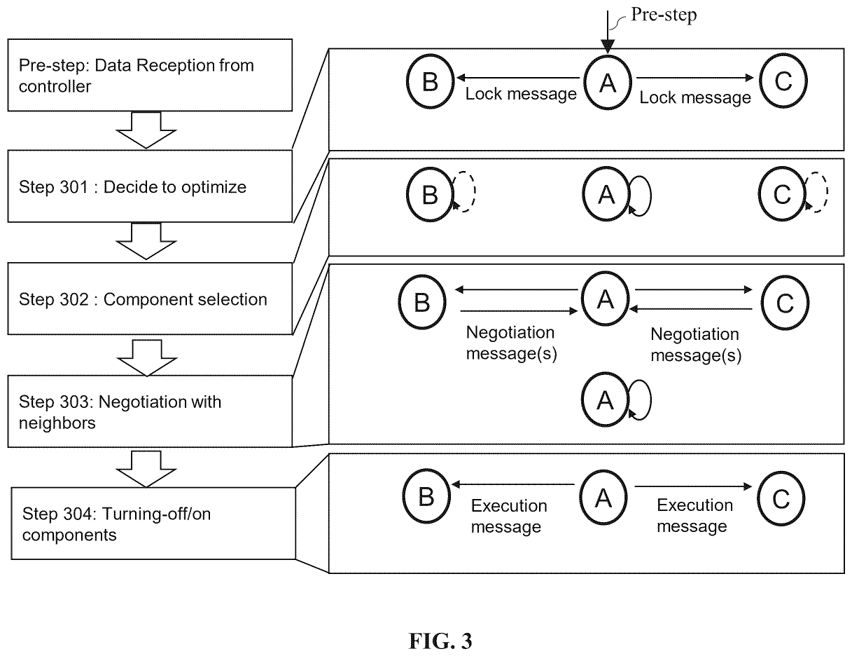

FIG. 3 shows a process that may be performed by an energy optimization agent according to embodiments of the present disclosure.

The left-hand side of FIG. 3 shows possible steps executable by the agent. As a prerequisite for energy optimization (pre-step in FIG. 3), the target node (and correspondingly, the agent) may be configured to obtain an energy profile of the target node. The energy profile comprises a device layout (or internal layout) of the target node and the energy consumption of each component (e.g., ports attached to chipsets, chipsets attached to boards, and power consumption of each component). In an embodiment of the present disclosure, a neighbor node may be adapted to similarly receive its own device layout and energy consumption information from the network.

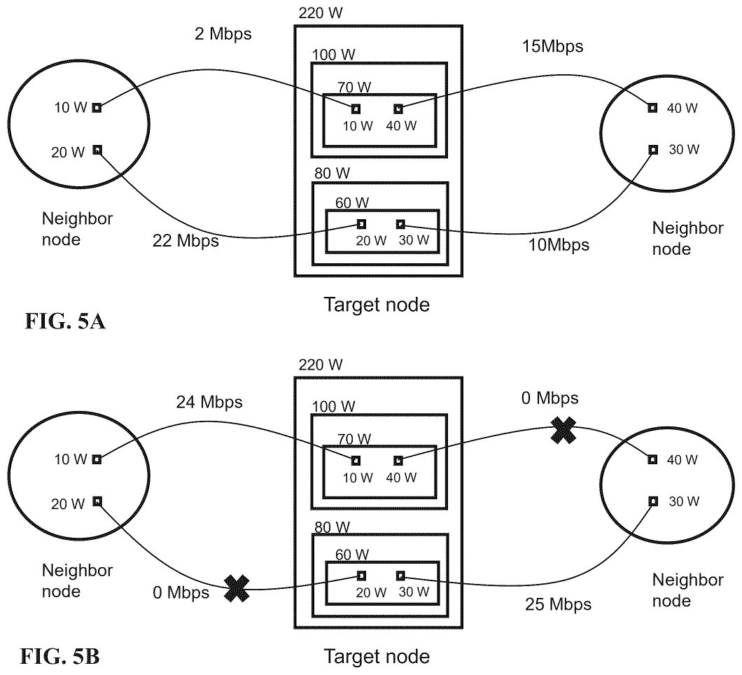

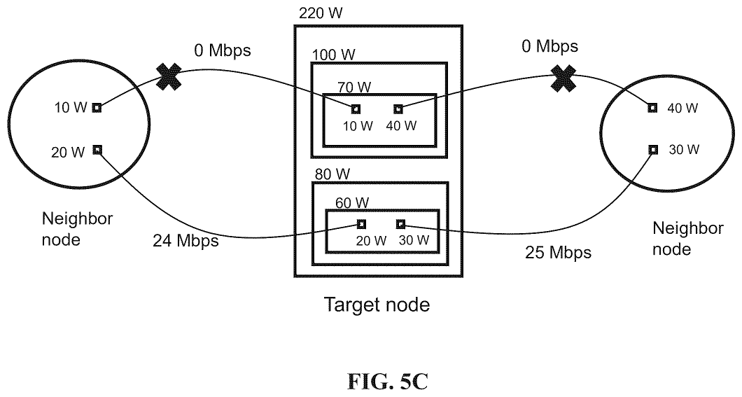

For instance, an energy profile may be referred to as an energy profile message (msg.) and may comprise the following information: {Device #D1, 220 W; Board #B1, 100 W; Board #B2, 80 W; Chipset #C11->Board #B1, 70 W; Port #P111->Chipset #C11, 10 W; Port #P112->Chipset #C11, 40 W; Chipset #C21->Board #B2, 80 W; Port #P211->Chipset #C21, 20 W; Port #P212->Chipset #C21, 30 W}, which can represent topology information of the components (e.g., boards, chipsets, and ports) and energy consumption of each component. An example network device corresponding to this energy profile is illustrated in FIGS. 5A-5C, which is to be discussed later.

In step 301, each agent (of any network device hosting an agent) may be adapted to decide whether the associated network device needs energy optimization. The decision may be periodic, or based on a threshold. In the periodic scenario, a goal may be to select one target node from a plurality of connected nodes at each iteration for energy optimization. The agent may be configured to compute a “stable set” comprising a plurality of potential target nodes, where a relative maximum energy consumption (or lowest energy efficiency) can be potentially achieved by optimizing the plurality of potential target nodes in the stable set. It is noted that for every node in the stable set, its associated neighbor node(s) shall not be in the stable set.

Protocols such as Link State Advertisements (LSAs) may be used to broadcast energy consumption of each network device. At each iteration, one or more network devices with the highest energy consumption (or lowest energy efficiency) are selected from the stable set for energy optimization. The selected network devices may be adapted to execute the optimization process synchronously. For instance, synchronization may be achieved using a master node, a shared clock, etc. Each selected network device may be seen as a target node. This task is NP-hard but efficient heuristics exist. Since all network devices receive the same energy consumption, and use the same deterministic algorithm, all nodes can determine the same stable set.

In embodiments of the present disclosure, without using the stable set, the optimization process may be executed asynchronously. For instance, at a specific time period, an agent is adapted to perform energy optimization for a specific node. The agent may be adapted to send a “lock” message to the one or more neighbor nodes. In this case, the one or more neighbor nodes are configured not to optimize their energy until a “unlock” message is received or after a pre-determined period of time. To avoid ping-pong effects, a minimum “off” duration may be set by the agent, or may be pre-determined among all the network devices. If a component or a network device is turned off, this component or network device cannot be woken up until the minimum off duration has passed.

In step 302, after a target node is selected for energy optimization, the agent associated with the target node is configured to determine one or more of the components to be set in a low-power state (e.g., to be turned off). This determination is based on the device layout of the target node and traffic information of LAGs associated with the target node. In an embodiment of the present disclosure, the traffic information may comprise network requirements for the multiple LAGs. The network requirements may comprise one or more of: a bandwidth requirement, QoS requirement, link utilization threshold of a respective LAG.

The determination can also take capabilities of neighbor nodes into consideration. Further, the determination can be seen as an optimization problem. Various algorithms can be applied in solving the optimization problem. In the following, an example model for performing energy optimization is explained. In this model, the energy saving can be maximized by deciding which components of the target node to switch off while ensuring that all traffic between the target node and the one or more neighbor nodes is ensured. In this example, the following notation is used:
e is used to denote a link between two units (or components, e.g. ports) d₁(e) and d₂(e);
unit (or component, e.g. port) d₁(e) belongs to a network node n; and
unit dᵢ(e) may be any unit that can be switched on/off of link e. For instance, unit dᵢ(e) may be a port pᵢ(e), a chipset cᵢ(e), a board bᵢ(e), or a node nᵢ(e) of link e.

The following notations are used as inputs or helpful information by the agent:
E: a set of links, wherein a LAG T may be at least a subset of E;
L: a set of LAGs;
D: a set of units (or components) in the node n;
e_{d}: energy consumption for unit d;
e^{b}∈ [symbol] ⁺: extra energy consumption of board b, related to the traffic spending through b;
cₑ: bandwidth capacity of link e∈E;
b(n, n′): traffic between node n and its neighbor node n′;
N(n): a set of neighbor nodes;
δ(d): a subset of links in E adjacent to d, d can be a node, board, chipset, or port;
δ(d₁, d₂): a subset of links in E adjacent between d₁ and d₂, i.e., δ(d₁, d₂)=δ(d₁)∩δ(d₂);
Fₙ: set of neighbor network devices equipped with an energy optimization agent;
n_{d}: node comprising port d;
b_{d}: board comprising port d; and
c_{d}: chipset comprising port d.

The agent may be adapted to obtain the following information as outputs:

$${x}_{e}^{n} :$$

split of traffic on link e∈E out of node n; and

$${t}_{d}^{n} = 1$$

if unit d∈D is turned off, otherwise

$${t}_{d}^{n} = 0 .$$

A cost function for the optimization problem to be solved by the agent of node n may be as follows:

$$max {\sum }_{d ∈ D} {e}_{d} {t}_{d}^{n} - {\sum }_{b oard b ∈ n} {e}^{b} {\sum }_{e ∈ δ ( b )} b ( n , {n}_{2} ( e ) ) {x}_{e}^{k}$$

subject to:

$${t}_{d}^{n} + {t}_{{c}_{d}}^{n} + {t}_{{b}_{d}}^{n} + {t}_{{n}_{d}}^{n} \leq 1 ∀ d ∈ {D}_{n} , d = port , {x}_{e}^{n} \leq {c}_{e} ( 1 - ( {t}_{{p}_{1} ( e )}^{n} + {t}_{{c}_{1} ( e )}^{n} + {t}_{{b}_{1} ( e )}^{n} ) ) \text{∀ e} ∈ δ ( n ) , {\sum }_{e ∈ T} ( {t}_{{p}_{1} ( e )}^{n} + {t}_{{c}_{1} ( e )}^{n} + {t}_{{b}_{1} ( e )}^{n} ) \leq \vert T \vert - 1 ∀ LAG T ∈ L , {\sum }_{e ∈ δ ( n , {n}^{′} )} {x}_{e}^{n} = b ( n , {n}^{′} ) ∀ {n}^{′} ∈ N ( n ) , {t}_{{p}_{1} ( e )}^{n} = 0 ∀ e ∈ δ ( n ) : {n}_{2} ( e ) ∉ {F}_{n} , {t}_{d}^{n} ∈ \{ 0 , 1 \} ∀ d ∈ {D}_{n}$$

The cost function to be maximized may be the energy that could be saved by switching off one or more components of node n. Extra energy consumption of board(s) may be considered that depends on the traffic spending through it. Therefore, in the objective function, the consumption of board(s) is subtracted.

The first constraint may be used to restrict the turned-off of nested devices to one device. This is to avoid counting the energy consumption multiple times. For instance, the energy consumption of a board includes the energy consumption of all included chipsets and ports. Therefore, turning off the boards implies turning off all included chipsets and ports.

The second constraint may represent physical link capacity constraints. It also allows linking the variables of x and t.

The third constraint may be used to guarantee that at least one physical link is active in every LAG.

The fourth constraint may be used to ensure that the traffic load on the LAG (between node n and its neighbor n′) is totally split over the links of the LAG.

The fifth constraint may be used to forbid turning off links between node n and the neighbor nodes that are not equipped with an energy optimization agent.

The sixth constraint may be used to ensure that

$${t}_{d}^{n}$$

has a value of either 0 or 1, depending on whether unit d is switched on or off.

The above model can be adapted to avoid turning off a recent woken-up device with further constraints, e.g., in order to avoid as much as possible changing neighbors' decisions taken at previous iterations. The model can also be embedded with QoS or link utilization constraints.

It is noted that the above model is merely given as a possible algorithm for solving the energy optimization problem. The parameters and constraints may be adapted in various ways.

In step 303, based on whether a corresponding neighbor node comprises a corresponding agent or not, the agent may be configured to send its optimization decision to a neighbor node having an agent. The optimization decision may be carried via a negotiation message (msg.) and may comprise ports and/or physical links of the LAGs that are to be set in a low-power state. Based on the negotiation msg., the agent of a corresponding neighbor may be adapted to decide a consistent set of components of the neighbor node to be set in a low-power state. It is noted that step 303 is optional and is not essential for optimizing energy consumption of the target node. For example, when the stable set is determined in step 302, step 303 is not necessary and this negotiation phase can be avoided.

In step 304, the agent is configured to request the one or more neighbor nodes to turn on/off the corresponding links/ports of the LAGs, e.g. by sending an execution message. Before turning off the corresponding links, each agent (or each node) may be adapted to off-load traffic of the corresponding links. When all ports of a chipset are in a low-power state (e.g., turned off), the corresponding chipset is also turned off. When all chipsets of a board are turned off, the corresponding board is also turned off. This is because the energy consumption of a component may not be exactly equal to a total energy consumption of all sub-components. For instance, a chipset may consume 70 W, while all its ports may consume 50 W in total. The energy profile according to this disclosure may provide useful input information for the agent to reach an improved energy optimization decision.

FIG. 3 on the right-hand side illustrates protocol messages involved in the steps shown on the left-hand side. The illustration of the protocol messages is based on three nodes A, B and C as an example. In this example, node A is the target example, nodes B and C are neighbor nodes of node A.

As a prerequisite, each node may be adapted to receive its energy profile. The energy profile may be fixed and provided as part of device configuration from vendors. In an embodiment of the present disclosure, the energy profile may be provided by a network controller.

In step 301, it is decided that energy optimization is performed on node A. This kind of decision may be made periodically, or may be triggered by neighbor nodes, or may be based on a threshold check. For instance, the following condition may be checked by each node:

$$\frac{Energy consumption of the node}{Current amount of traffic in the node} < Threshold \qquad ( Eq . 1 )$$

According to Eq. 1, if the ratio defined by Eq. 1 is equal to or above a pre-determined threshold, it means that the node may waste too much energy and make too little contribution to the traffic of the LAGs. Thus, this node needs energy optimization. In this example, node A is selected as a target node. As a result, neighbor nodes B and C are not selected as target nodes. In embodiments of the present disclosure, as neighbor nodes that are not in a stable set, nodes B and C are not selected as target nodes by default. If no stable set is defined, node A may be configured to send a lock message to nodes B and C. In this way, no concurrent optimization can be performed among adjacent nodes, which otherwise may lead to conflicting configurations. In an embodiment of the present disclosure, the lock message may comprise a time duration or expiration, which defines a minimum duration during which no energy optimization shall be performed on the neighbor nodes B and C. In embodiments of the present disclosure, the target node A may be configured to send an unlock message to the neighbor nodes B and C in order to cancel the lock message.

In step 302, node A is configured to solve the optimization problem stated above for energy optimization. It is noted that nodes B and C not being selected as target nodes shall be understood that nodes B and C are not adapted to make any final decision for energy optimization. The final decision for energy optimization shall be made by the target node A (or by the agent of the target node A). However, as illustrated in FIG. 3, nodes B and C may be adapted to make local decisions (or suggestions) by solving the same energy optimization problem if nodes B and C comprise a respective agent. The local decisions may be used to negotiate with the target node A.

In step 303, the local suggestions made by neighbor nodes B and C may comprise preferred components to turn on/off and may be sent to the target node A. It is noted the target node A may be configured to intersect the one or more components of the target node A that are set to the low-power state and the one or more components of the respective neighbor nodes B and C that are set to the low-power state, to obtain a list of links to be adjusted. If a consensus decision is reached, the list of links to be adjusted may be seen as a final decision. In an embodiment of the present disclosure, the negotiation may be iterated several rounds until such a consensus decision is reached. It is noted that reaching a consensus decision may be understood that no conflicting component to be turned off is detected in all the decisions made by all the nodes, and/or routing of the network is not interrupted.

The target node A may be configured to optimize the energy consumption by adjusting the links of the multiple LAGs according to the list defined in the final decision. To this end, the target node A may be configured to send the final decision to the neighbor nodes B and C for execution. In step 304, the target node A may be configured to send the final decision via an execution message to neighbor nodes B and C. The execution message may be used to request neighbor nodes B and C to turn off one or more certain components (e.g. ports) in the LAGs. For each node, if all ports of a chipset are off, then the chipset is also turned off. Similarly, if all chipsets of a board are off, then the board is also turned off. This can further save energy.

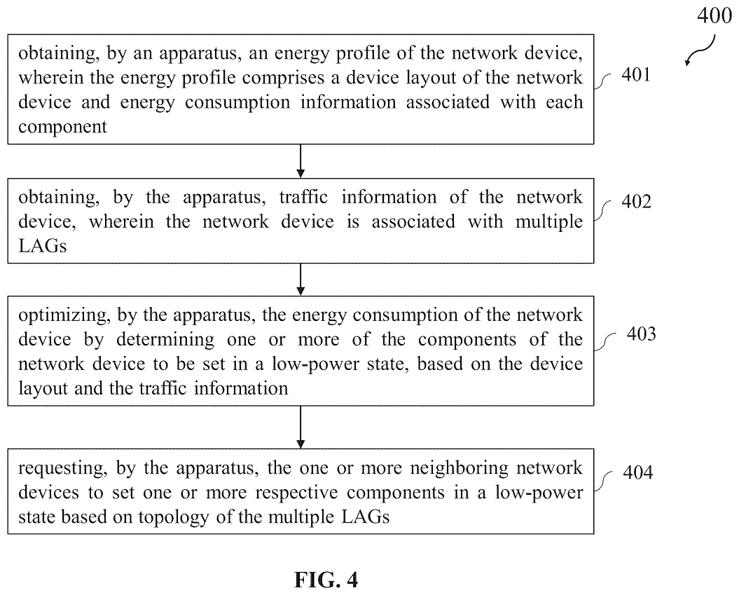

FIG. 4 shows a diagram of a method 400 according to embodiments of the present disclosure.

The method 400 is for optimizing energy consumption of a (target) network device. The target network device is connectable with one or more neighboring network devices. Each network device comprises multiple components such as boards, chipsets and ports. The method 400 comprises the following steps:
step 401: obtaining, by an apparatus, an energy profile of the network device, wherein the energy profile comprises a device layout of the network device and energy consumption information associated with each component;
step 402: obtaining, by the apparatus, traffic information of the network device, wherein the network device is associated with multiple LAGs;
step 403: optimizing, by the apparatus, the energy consumption of the network device by determining one or more of the components of the network device to be set in a low-power state, based on the device layout and the traffic information; and
step 404: requesting, by the apparatus, the one or more neighboring network devices to set one or more respective components in a low-power state based on topology of the multiple LAGs.

In an embodiment of the present disclosure, the apparatus may be an energy optimization agent, which may be a unit of the target network device.

It should be noted that the steps of the method 400 may share the same functions and details from the perspective of FIGS. 1-3 described above. Therefore, the corresponding method implementations are not described in detail again at this point.

FIGS. 5A and 5C show an example of energy optimization according to embodiments of the present disclosure and FIG. 5B shows a conventional method of energy optimization.

FIG. 5A illustrates a scenario before energy optimization. In this example, energy optimization is performed on a target node A in the middle of FIG. 5A. The target node A with a total energy consumption of 220 W comprises components of two boards with 100 W and 80 W, respectively. The first board with 100 W comprises a chipset with 70 W. The chipset with 70 W comprises two ports with 10 W and 40 W. The second board with 80 W comprises a chipset with 80 W. The chipset with 80 W comprises two ports with 20 W and 30 W. This device layout and energy consumption can be presented as an energy profile of the target node A as mentioned above in FIGS. 1-3.

FIG. 5B illustrates a conventional method where a lowest port energy consumption strategy is employed. It is noted ports with the lowest energy consumption of each LAG (10 W and 30 W) are chosen to be turned on, while ports with 40 W and 20 W are chosen to be turned off. According to this method, an energy saving of 120 W (40 W+40 W+20 W+20 W) is achieved.

FIG. 5C illustrates a coordinated energy optimization taking account of device topology according to this disclosure. In FIG. 5C, links of the multiple LAGs are turned off in a coordinated way: according to the energy profile of the target node A, ports with 10 W and 40 W are turned off, while ports with 20 W and 30 W are turned on. It is noted that since all ports inside the first chipset with 70 W are turned off, the first chipset (70 W) itself is also turned off. Since the first chipset is turned off, the board with 100 W is also turned off. In this way, an increased energy saving of 150 W (100 W+10 W+40 W) is achieved, which leads to a 25% improvement in comparison to the conventional method.

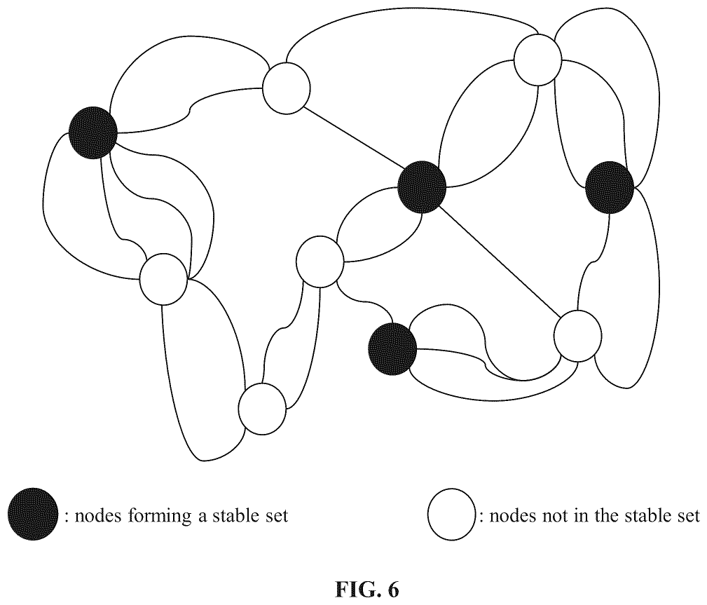

FIG. 6 shows an example of a stable set according to embodiments of the present disclosure. FIG. 6 shows a plurality of network nodes. Every two adjacent nodes may be connectable using one or more links, which forms a LAG. For performing network energy optimization, it may be beneficial to determine a stable set among these network nodes. The stable set may be determined according to the following two principles. Firstly, a node in the stable set may be the (relatively) highest with respect to its energy consumption among its neighborhood (one or more neighbor nodes). As mentioned previously, the energy consumption may be broadcast via LSA, so that each node may be aware of the energy consumption of other node(s). Secondly, any two directly adjacent nodes shall be not in the stable set at the same time (or any two nodes in the stable set shall be not neighbor nodes).

In FIG. 6, each node (hosting a respective energy optimization agent) in the stable set can be independently configured to perform energy optimization using the solution disclosed in the present disclosure. It is not necessarily for each node in the stable set to negotiate its optimization decision with its neighborhood.

In an embodiment of the present disclosure, the nodes in the stable set may be synchronized, e.g., using a master node (chosen from the stable set), based on a shared clock, etc.

The present disclosure may be applied to any communications network where LAG is involved, such as a local area network, and wired area network. In some cases, this disclosure can also be applied to wireless communication networks where a wireless network device comprising wireless communication components that can be individually switched on/off for each communication channel/link. This is similar to the scenario of LAG and thus, the solution according to the present disclosure can be applied.

The device in the present disclosure may comprise processing circuitry (not shown) configured to perform, conduct or initiate the various operations of the device described herein, respectively. The processing circuitry may comprise hardware and software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The processing circuitry comprises one or more processors and a non-transitory memory connected to the one or more processors. The non-transitory memory may carry executable program code which, when executed by the one or more processors, causes the device to perform, conduct or initiate the operations or methods described herein, respectively.

In an embodiment, the device in the present disclosure may be a single electronic device capable of computing, or may comprise a set of connected electronic devices capable of computing with a shared system memory. It is well-known in the art that such computing capabilities may be incorporated into many different devices, and therefore the term “device” may comprise a PC, server, mobile terminal, tablet, wearable device, game console, graphic processing unit, graphic card, and the like.

The present disclosure has been described in conjunction with various examples as well as implementations. However, other variations can be understood and effected by those persons skilled in the art and practicing the claimed subject matter, from the studies of the drawings, this disclosure, and the independent claims. In the claims as well as in the description the word “comprising” does not exclude other elements or steps and the indefinite article “a” or “an” does not exclude a plurality. A single element or another unit may fulfill the functions of several entities or items recited in the claims. The mere fact that certain measures are recited in the mutual different dependent claims does not indicate that a combination of these measures cannot be used in an advantageous implementation.

1. An apparatus for optimizing energy consumption of a network device, the network device being connectable with one or more neighboring network devices, and each network device comprising multiple components, the apparatus comprising processing circuitry, which is configured to:
obtain an energy profile of the network device, wherein the energy profile comprises a device layout of the network device and energy consumption information associated with each component of the network device;
obtain traffic information of the network device, wherein the network device is associated with multiple link aggregation groups (LAGs);
optimize the energy consumption of the network device by determining one or more of the components of the network device to be set in a low-power state, based on the device layout and the traffic information; and
request the one or more neighboring network devices to set one or more respective components in the low-power state based on a topology of the multiple LAGs and the determined one or more components of the network device to be set in the low-power state.

2. The apparatus according to claim 1, wherein obtaining the energy profile of the network device comprises receiving, by the apparatus,
the energy profile of the network device from a controller device.

3. The apparatus according to claim 1, wherein the processing circuitry is further configured to inform the one or more neighboring network devices about the determined one or more components that are to be set to the low-power state.

4. The apparatus according to claim 1, wherein the processing circuitry is further configured to obtain, from a respective neighboring network device of the one or more neighboring network devices, an indication of one or more components of the respective neighboring network device that are to be set to the low-power state.

5. The apparatus according to claim 4, wherein the processing circuitry is further configured to:
intersect the determined one or more of the components of the network device that are set to the low-power state and the one or more components of the respective neighboring network device that are set to the low-power state, to obtain a list of links to be adjusted; and
optimize the energy consumption of the network device by adjusting the links in the multiple LAGs according to the list.

6. The apparatus according to claim 5, wherein the apparatus is further processing circuitry to provide the list of links to be adjusted to the one or more neighboring network devices.

7. The apparatus according to claim 1, wherein the processing circuitry is configured to optimize the energy consumption of the network device based on a distributed algorithm, wherein according to the distributed algorithm the processing circuitry is configured to:
obtain the energy consumption information of the network device;
broadcast the energy consumption information of the network device;
receive further energy consumption information of one or more other network devices of the one or more neighboring network devices; and
optimize the energy consumption of the network device in response to determining that the energy consumption information of the network device is the highest among the energy consumption information of the network device and the further energy consumption information of the one or more other network devices.

8. The apparatus according to claim 7, wherein the network device and the one or more other network devices are in a stable set, wherein any two network devices in the stable set are not neighboring network devices.

9. The apparatus according to claim 1, wherein the processing circuitry is configured to optimize the energy consumption of the network device periodically.

10. The apparatus according to claim 1, wherein the processing circuitry is configured to optimize the energy consumption of the network device based on a triggering message received from the one of the one or more neighboring network devices.

11. The apparatus 1 according to claim 1, wherein the processing circuitry is configured to optimize the energy consumption of the network device based on a threshold, wherein the threshold is associated with the energy consumption of the network device and a current traffic status of the network device.

12. The apparatus according to claim 1, wherein for optimizing the energy consumption of the network device, the processing circuitry is further configured to send a lock message to the one or more neighboring network devices, wherein the lock message is used to instruct the one or more neighboring network devices not to perform energy optimization.

13. The apparatus according to claim 12, wherein the lock message comprises a time duration and the lock message is further used to instruct the one or more neighboring devices not to perform energy optimization at least within the time duration.

14. The apparatus according to claim 12, wherein the processing circuitry is further configured to send an unlock message to the one or more neighboring network devices, wherein the unlock message is used to cancel the lock message.

15. The apparatus according to claim 1, wherein the traffic information comprises network requirements for the multiple LAGs, wherein the network requirements comprise one or more of a bandwidth requirement, Quality-of-Service (QoS) requirement, and link utilization threshold of a respective LAG of the multiple LAGs.

16. The network device, comprising the apparatus according to claim 1.

17. The network device according to claim 16, wherein the network device is a router, a switch, a repeater, a bridge, or a gateway.

18. A method for optimizing energy consumption of a network device, the network device being connectable with one or more neighboring network devices, and each network device comprising multiple components, the method comprising:
obtaining, by an apparatus, an energy profile of the network device, wherein the energy profile comprises a device layout of the network device and energy consumption information associated with each component of the network device;
obtaining, by the apparatus, traffic information of the network device, wherein the network device is associated with multiple link aggregation groups (LAGs);
optimizing, by the apparatus, the energy consumption of the network device by determining one or more of the components of the network device to be set in a low-power state, based on the device layout and the traffic information; and
requesting, by the apparatus, the one or more neighboring network devices to set one or more respective components in the low-power state based on a topology of the multiple LAGs.

19. A non-transitory computer readable storage medium comprising a computer program comprising instructions which, when the program is executed by a computer, causes the computer to perform a method for optimizing energy consumption of a network device, the network device being connectable with one or more neighboring network devices, and each network device comprising multiple components, wherein the method comprises:
obtaining an energy profile of the network device, wherein the energy profile comprises a device layout of the network device and energy consumption information associated with each component of the network device;
obtaining traffic information of the network device, wherein the network device is associated with multiple link aggregation groups (LAGs);
optimizing the energy consumption of the network device by determining one or more of the components of the network device to be set in a low-power state based on the device layout and the traffic information; and
requesting the one or more neighboring network devices to set one or more respective components in the low-power state based on a topology of the multiple LAGs.
